(19) United States
(12) Patent Application Publication
(10) Pub. No.: US 2005/0114146 A1
(43) Pub. Date: May 26, 2005

(54) Commemorative donation system and method

(76) Inventor: Joan Barkley, Sunshine (AU)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/416,580

(22) PCT Filed: Nov. 22, 2001
(86) PCT No.: PCT/AU01/01518

(30) Foreign Application Priority Data
Nov. 23, 2000 (AU) PR 1650

(51) Int. Cl. G06F 17/60

(52) U.S. Cl. 705/1

(57) ABSTRACT

A method for facilitating commemorative donations, including the steps of: (a) nominating one or more charitable organisations (3) to which donations may be made to commemorate a person, place or event; (b) publishing details (10, 11 22) of the nominated charitable organisations; (c) accepting donations to one or more of the charitable organisations from one or more donors (2); (d) distributing funds (112) to the nominated charitable organisations to which donations have been made; and (e) publishing an acknowledgment (23) of the person, place or event and the nominated charitable organisations to which donations have been made.

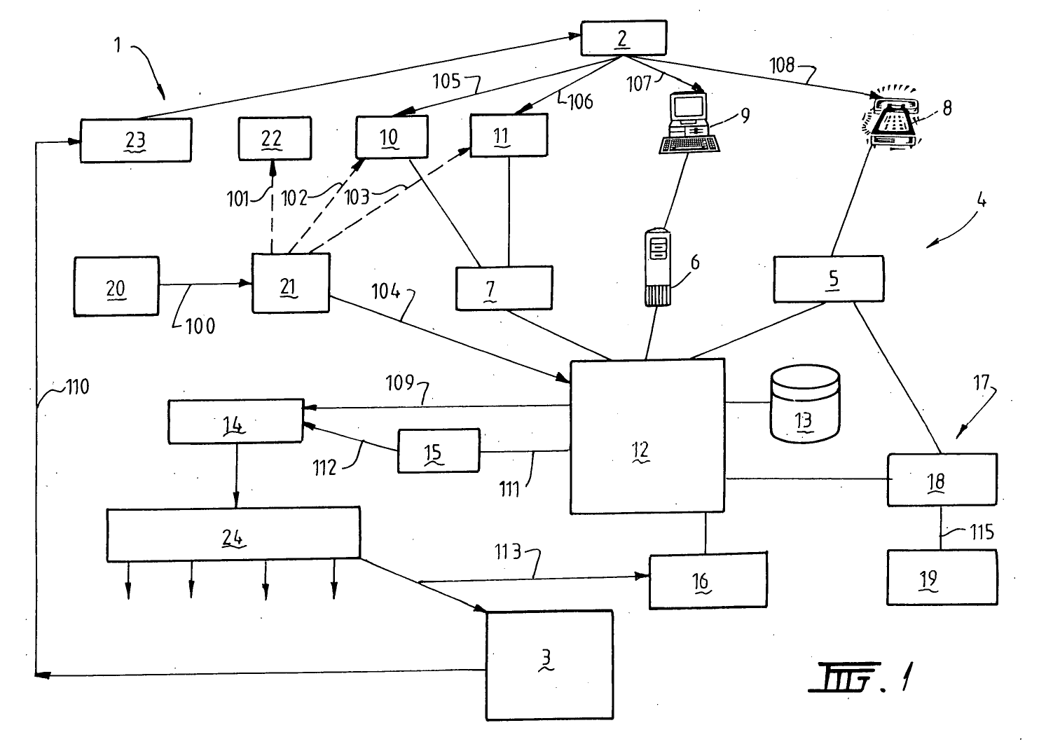

The present invention relates generally to donation methods and systems, and in particular to donation systems and methods for commemorating a person, place or event. The invention is suitable for use in accepting, processing and acknowledging donations made to charitable organisations to commemorate a deceased person, and it will be convenient to describe the invention in relation to that exemplary application. It is to be appreciated, however, that the invention is not limited to that application.

Upon the death of a family member or friend, it is known for the trustee of the deceased person's estate to request that donations commemorating the deceased person be paid to one or more charitable organisations rather than money being spent on flowers or other socially less worthwhile commemorations. Bereaved family members or friends may then directly contact one or more of the charitable organisations nominated by the trustee, and arrange for a cheque or other means of payment to be forwarded.

Whilst this arrangement benefits those nominated charitable organisations nominated which donations are made, it is inefficient in the identification of the charitable organisation and the distribution of funds to those organisations. Moreover, this arrangement provides no means of publicly commemorating the deceased individual in whose name the donation was made.

It would therefore be desirable to provide a commemorative donation system and method that simplifies and improves the efficiency and effectiveness of the making of commemorative donations to charitable organisations.

It would also be desirable to provide a commemorative method and system that elevates or overcomes one or more disadvantages of known donation methods and systems.

With this in mind, one aspect of the present invention provides a method for facilitating commemorative donations via a data communications network, including the steps of:
(a) nominating one or more charitable organisations to which donations may be made to commemorate a person, place or event;
(b) publishing details identifying the nominated charitable organisations;
(c) accepting donations, via a donations processing system, to one or more of the charitable organisations from one or more donors;
(d) distributing funds, via a management system, to the nominated charitable organisations to which donations have been made; and
(e) publishing an acknowledgment of the person, place or event and the nominated charitable organisations to which donations have been made.

The one or more charitable organisations may be nominated in step (a) by selecting one of a plurality of charity categories, each said charity category grouping one or more charitable organisations. Charitable organisations may be grouped into charity categories such as hospitals and medical research, environment, community services, child welfare, aged care, the physically and intellectually impaired, the arts, and overseas aid. Donations may be made by said one or more donors in step (c) by selection of one or more charity categories.

Alternatively, the one or more charitable organisations may be directly nominated in step (a).

In one embodiment, the one or more charitable organisations may be nominated in step (a) by a trustee or other representative of the commemorated person, place or event.

In another embodiment, the one or more charitable organisations may be nominated in step (a) by an agent of the charitable organisations. No specific charities or charity categories need be specifically nominated by the trustee or other representative of the commemorated person, place or event in this example.

Step (a) may include the trustee or other representative of a commemorated person, place or event advising an intermediary, such as a funeral director, of said one or more charitable organisations. The intermediary may be advised by the trustee contacting a management system, the management system then contacting the intermediary.

The management system may be adapted to select the intermediary without the active participation of the trustee.

Step (b) may include publishing said details in the form of a notice, printed envelopes or coupons. The details are published in print media and/or published electronically.

Step (c) may includes providing information identifying said one or more charitable donations to which a donation is to be made, the amount of the donation, and the source of funds from the donation will be made to a management system. Information charactering the donor may also be provided.

Step (d) may includes transferring funds corresponding to the donations made into a financial account, and subsequently transferring at least a portion of those funds into one or more trust accounts maintained by each said charitable organisation. The funds may be maintained in said trust accounts for a predetermined period, at least a portion of the funds being transferred to an administration account during that period. The funds may be transferred from said trust accounts to other accounts maintained for said charitable organisations after said predetermined period.

Step (e) may includes providing details of a commemorated person, place or event and the nominated charitable organisations to an advertising agency, said advertising agency then arranges for the publication of said acknowledgment. The acknowledgment may be published in print media and/or published electronically.

In one embodiment, each nominated charitable organisation provides a communication of acknowledgment to the donor subsequent to step (c).

Another aspect of the present invention provides a commemorative donation system for performing the method described above, comprising:
a donation processing system for accepting donations from one or more of said donors to one or more said nominated charitable organisations to commemorate a person, place or event;
a management system for recording details of the commemorated person, place or event and the nominated charitable organisations to which donations have been made, and for directing the distribution of donated funds to said nominated charitable organisations; and
an acknowledgment system for publishing an acknowledgment of the commemorated person, place or event and the nominated charitable organisations to which donations have been made.

Upon receiving information from a trustee of a commemorated person, place or event identifying of said one or more charitable organisations, said management system may act to contact an intermediary to advise of said one or more charitable organisations. The management system may be adapted to select the intermediary without the active participation of the trustee. The donation processing system may be adapted to receive information identifying said one or more charitable donations to which a donation is to be made, the amount of the donation, and the source of funds from the donation will be made to a management system. The donation processing system may be further adapted to receive information charactering the donor.

The donation processing system may include a call centre for receiving communications from one or more telephone terminals. The donation processing system may also or alternatively include an Internet server for processing communications from one or more computer terminals. The donation processing system may also or alternatively include a data processing system for the extraction of information from manually or automatically completed forms.

The management system may act to transfer funds corresponding to the donations made into a financial account, and subsequently transfer at least a portion of those funds into one or more trust accounts maintained by each said charitable organisation. The funds may be maintained in said trust accounts for a predetermined period, at least a portion of the funds being transferred to an administration account during that period. The funds may be transferred from said trust accounts to other accounts maintained for said charitable organisations after said predetermined period.

The management system may act to provide details of a commemorated person, place or event and the nominated charitable organisations to an advertising agency, said advertising agency then arranging for the publication of said acknowledgment. The acknowledgment may be published in print media and/or published electronically.

The following description refers to a preferred embodiment of the commemorative donation method and system of the present invention. To facilitate an understanding of the invention, reference is made in the description to the accompanying drawing where a schematic diagram and flow chart of the invention is illustrated. It is to be understood that the commemorative donation method and system is not limited to the preferred embodiment as hereinafter described and illustrated in the drawing.

Referring to the drawing, there is shown generally a commemorative donation system 1 to facilitate the making of donations to commemorate a person, place or event, such as a deceased individual, from a donor 2 to one or more charitable organisations 3. The commemorative donation system 1 comprises a donation processing system 4 including, in this example, a telephone call centre 5, an Internet server 6 and data processing system 7. The call centre 5 is adapted to receive and process information from a telephone terminal 8. Typically, the call centre 5 may be fully automated and provided with either a voice or tone recognition capabilities to capture information provided from the telephone terminal 8.

Alternatively, the call centre 5 may include one or more human operators who may obtain information from users of the telephone terminal 8 and enter that information into a computerised or other terminal forming part of the commemorative donation system 1.

In other embodiments of the invention, donors may use the telephone terminal 8 to access a 1900 premium rate or like telephone number to have a nominated or set amount charged to their telephone account. The management system 12 may then allow the donor to leave transcription details via an automated system or via a phone operator after the nominated or drop charge amount has been recorded.

The Internet server 6 is adapted for communication with a remote computer terminal 9. The Internet server 6 typically hosts an Internet site by which a user of the remote computer terminal 9 is able to provide information that is then captured by the Internet server 6.

The data processing system 7 comprises a manual or automatic system for the extraction of information from manually or automatically completed forms, such as an envelope 10 or coupon 11, and the reformatting of that information into electronic format for further processing by the commemorative donation system 1.

Each of the above described elements of the donation processing system 4 are adapted to capture information identifying donations made be the donor 2 to the one or more charitable organisations 3, and to provide this donation information to a management system 12. It will be appreciated that in other forms of the invention, users interfaces other than the telephone terminal 8, computer terminal 9, coupon 11 and envelope 10 may be used, and that data conversion devices and systems other than the call centre 5, Internet server 6 and data processing system 7 may be used.

The management system 12 acts to record details of a deceased individual, or other commemorated person, place or event, and charitable organisations that have been nominated by the trustee of the estate of the deceased person to receive donations commemorating that deceased person. These details are stored within records maintained in a database 13 forming part of, or being accessible to, the management system 12. The management system 12 may typically be computerised and comprise a data processing device operatively connected to a program storage area for storing program code determinative of the functionality system 12, and one or more further temporary data storage areas. One or more parts of the management system 12 may alternatively be implemented in a non-computerised environment, the functionality of the management system 12 being performed by administrative staff.

The records maintained in the database 13 may additionally store details of a trustee 14 of one or more of the charitable organisations 3, details of one or more financial accounts 15 and 16, respectively for use in the distribution of funds received by the management system 12, and for the processing of costs and fees associated with the management of the management and use of the commemorative donation system 1. Details identifying the donor 2 may also be recorded in the database 13.

The commemorative donation system 1 also includes an acknowledgment system 17 for publishing and acknowledgment of the commemorated person, place or event or which ever of the charitable organisations 3 have been nominated to receive donations made on behalf of that commemorated person, place or evert. In this example, the acknowledgment system 17 includes an advertising agency 18 and newspaper 19 or other print or electronic media. The acknowledgment system 17 acts to receive information from the management system 12 in order to facilitate the publication of acknowledgment details by via the media publication system 19. The acknowledgment system 6 may also be in direct communication with the telephone call centre 5 or other element within the donation processing system 4.

In operation, the trustee 20 of the estate of a deceased individual initially makes contact, at step 100, with a funeral director 21 or other intermediary, and advises the funeral director of the charitable organisations and/or trustees to whom it is desired donations commemorating a deceased person are to be made. The funeral director 21 may be contacted directly by the trustee 20, or indirectly via the management system 12. The management system 12 may also be adapted to select a funeral director 21 without requiring the participation of the trustee 20.

In other embodiments of the invention, the charitable organisations may be grouped into one or more charity categories, the trustee 20 of the estate of a deceased individual initially nominating one of a plurality of such charity categories. Charitable organisations may be grouped into charity categories such as hospitals and medical research, environment, community services, child welfare, aged care, the physically and intellectually impaired, the arts, and overseas aid. Donations may subsequently be made by one or more donors by selection of one or more charity category.

Similarly, the charitable organisations need not necessarily be nominated by the trustee 20 of the commemorated person, place or event, but may be nominated by an agent of the charitable organisations. In this way, no specific charity or charity category need be nominated by the trustee 20, but an agent such as the administrator of the management system 12 may nominate charitable organisations or charity categories of charitable organisations participating in the commemorative donation system.

Upon receipt of information identifying the charitable organisations 3 or their trustee 14, and details of the person, place or event that are to be commemorated by donations to the nominated charitable organisations, the funeral director 21 at step 101 to 103 attends to the publication of details identifying the nominated charitable organisations to which it is intended donations are to be made. In the present example, the publications take the form of a funeral notice 22 or other notice, printed envelopes 10 and coupons 11. The printed envelopes 10 may be made available at the funeral for the deceased person and enable donations to be made at or shortly after the funeral.

The funeral notice 22 may contain details of a dedicated telephone number, such as a toll free number so that the donor 2 can use the telephone terminal 8 to contact the telephone call centre 5 and request that a donation be made. The funeral notice 22 may also include the uniform resource locator of the website hosted on the Internet server 6 so that the donor 2 can use the remote computer terminal 9 to make a donation. Various other types of information may also be included in the funeral notice 22.

It will be appreciated that various other forms of publication of the charities that have been nominated by the trustee 20 for commemorating the deceased person may easily be envisaged, and any one or more of these forms of publication may include details identifying various manners in which donations may be made through the donation processing system 4. At step 104, information identifying the deceased person to be commemorated, and one or more nominated charitable organisations to which donations may be made, are provided by the funeral director to the management system 12. These details are then stored in corresponding records within the database 13.

In response to the publication of details identifying the nominated charitable organisations to which donations may be made to commemorate their deceased person, a donor 2 wishing to make a donation may then use one of the various elements provided by the donation processing system 4 to provide information at steps 105 to 108 to the management system 12 registering details of the one or more nominated charitable organisations to which a donation is to be made, the amount of that donation, and the banking or other financial source of funds from which the donation will be transferred. In addition, donor profile data identifying personal details of the donor, such as the donor's name and address, may be additionally provided for the management system 12.

A donor may select a charity from a list of published charitable organisations to which a donation is to be made. Alternatively, a donor can ask for donations to be made to one of a plurality of charity categories. The trustee 14 will then direct these funds to a reputable charitable organisation involved in that category.

The information provided by the donor 2 to the management system 12 is then forwarded at step 109 to the trustee 14 and to the charitable organisations in question. The charitable organisation(s) 3 subsequently provides a letter or other communication of acknowledgment 23, at step 110, to the donor 2 acknowledging and thanking them for the donation just made. The management system 12 then acts to transfer funds corresponding to the donations made at step 111, into the financial account 15, prior to distribution, at step 112, of these funds to the individual trust accounts 24 of the participating charitable organisations 3 as directed by the trustee 14.

The individual trust accounts 24 will typically retain funds corresponding to the donations made at step 111 in trust for the beneficiaries (the charitable organisations 3) for three months or other agreed predetermined period. Funds to cover the operational and management costs of the donation management system 1 will then be deduced on a monthly, quarterly or other periodic basis and paid to the administration financial account 16, maintained by the management system 12. The funds in the individual trust accounts 24 are subsequently distributed to a bank account in the name of each of charitable organisation to which donations have been made.

In order to publicly acknowledge the donations made to each of the nominated charitable organisations on behalf of the commemorated individual, the management system 12, at step 114, provides the advertising agency 18 with details of the commemorated individual and the nominated charitable organisations to which donations have been made. Optionally, details identifying the donor 2 may also be provided to the advertising agency 18.

At step 115, the advertising agency then arranges for the newspaper 19 to publish an acknowledgment page, identifying each charitable organisation to which donations have been made, the commemorated individual and optionally details of those donors that have chosen to make donations to the charitable organisations in commemoration of that deceased individual. Funds payment for the placement of the acknowledgment page in the newspaper 19 may be included in those funds transferred at step 113 into the administration financial account 16.

In other embodiments of the invention, the donation acknowledgment may not be published in traditional print media but may be published by other forms of publication, such as the electronic publication of text, audio or video content on the Internet or by transmission of an e-mail or e-mail attachment.

It will be appreciated that various modifications and additions may be made to the commemorative donations system and method hereabove without departing from the spirit or ambit of the present invention.

1. A method for facilitating commemorative donations via a data communications network, including the steps of:
(a) nominating one or more charitable organisations to which donations may be made to commemorate a person, place or event;
(b) publishing details identifying the nominated charitable organisations;
(c) accepting donations, via a donations processing system, to one or more of the charitable organisations from one or more donors;
(d) distributing funds, via a management system, to the nominated charitable organisations to which donations have been made; and
(e) publishing an acknowledgment of the person, place or event and the nominated charitable organisations to which donations have been made.

2. A method according to claim 1, wherein the one or more charitable organisations are nominated in step (a) by selecting one of a plurality of charity categories, each said charity category grouping one or more charitable organisations.

3. A method according to claim 2, wherein donations are made by said one or more donors in step (c) by selection of one or more charity categories.

4. A method according to claim 1, wherein the one or more charitable organisations are directly nominated in step (a).

5. A method according to any one of the preceding claims, wherein the one or more charitable organisations are nominated in step (a) by a trustee or other representative of the commemorated person, place or event.

6. A method according to any one of claims 1 to 4, wherein the one or more charitable organisations are nominated in step (a) by an agent of the charitable organisations.

7. A method according to any one of the preceding claims, wherein step (a) includes:
a trustee of a commemorated person, place or event advising an intermediary of said one or more charitable organisations.

8. A method according to claim 7, wherein
said intermediary is advised by the trustee contacting a management system, and the management system then contacting the intermediary.

9. A method according to claim 8, wherein
the management system is adapted to select the intermediary without the active participation of the trustee.

10. A method according to any one of the preceding claims, wherein step (b) includes:
publishing said details in the form of a notice, printed envelopes or coupons.

11. A method according to claim 10, wherein
said details are published in print media.

12. A method according to either one or claims 10 or 11, wherein
said details are published electronically.

13. A method according to any one of the preceding claims, wherein step (c) includes:
providing information identifying said one or more charitable donations to which a donation is to be made, the amount of the donation, and the source of funds from the donation will be made to a management system.

14. A method according to claim 13, and further including:
providing information charactering the donor.

15. A method according to any one of the preceding claims, wherein step (d) includes:
transferring funds corresponding to the donations made into a financial account, and subsequently transferring at least a portion of those funds into one or more trust accounts maintained by each said charitable organisation.

16. A method according to claim 15, wherein
the funds are maintained in said trust accounts for a predetermined period, at least a portion of the funds being transferred to an administration account during that period.

17. A method according to claim 16, wherein
the funds are transferred from said trust accounts to other accounts maintained for said charitable organisations after said predetermined period.

18. A method according to any one of the preceding claims, wherein step (e) includes:
providing details of a commemorated person, place or event and the nominated charitable organisations to an advertising agency,
said advertising agency then arranges for the publication of said acknowledgment.

19. A method according to claim 18, wherein
said acknowledgment is published in print media.

20. A method according to claim 18, wherein
said acknowledgment is published electronically.

21. A method according to any one of the preceding claims, and further including the step of:
each nominated charitable organisation providing a communication of acknowledgment to the donor subsequent to step (c).

22. A commemorative donation system for performing a method according to any one of the preceding claims, comprising:
a donation processing system for accepting donations from one or more of said donors to one or more said nominated charitable organisations to commemorate a person, place or event;
a management system for recording details of the commemorated person, place or event and the nominated charitable organisations to which donations have been made, and for directing the distribution of donated funds to said nominated charitable organisations; and
an acknowledgment system for publishing an acknowledgment of the commemorated person, place or event and the nominated charitable organisations to which donations have been made.

23. A commemorative donation system according to claim 22, wherein
upon receiving information from a trustee of a commemorated person, place or event identifying of said one or more charitable organisations, said management system acts to contact an intermediary to advise of said one or more charitable organisations.

24. A commemorative donation system according to claim 23, wherein
the management system is adapted to select the intermediary without the active participation of the trustee.

25. A commemorative donation system according to any one of claims 22 to 24, wherein
said donation processing system is adapted to receive information identifying said one or more charitable donations to which a donation is to be made, the amount of the donation, and the source of funds from the donation will be made to a management system.

26. A commemorative donation system according to claim 25, wherein
said donation processing system is further adapted to receive information charactering the donor.

27. A commemorative donation system according to either one of claims 25 or 26, wherein
said donation processing system includes a call centre for receiving communications from one or more telephone terminals.

28. A commemorative donation system according to any one of claims 25 to 27, wherein
said donation processing system includes an Internet server for processing communications from one or more computer terminals.

29. A commemorative donation system according to any one of claims 25 to 28, wherein
said donation processing system includes a data processing system for the extraction of information from manually or automatically completed forms.

30. A commemorative donation system according to any one of claims 22 to 29, wherein
the management system acts to transfer funds corresponding to the donations made into a financial account, and subsequently transferring at least a portion of those funds into one or more trust accounts maintained by each said charitable organisation.

31. A commemorative donation system according to claim 30, wherein
the funds are maintained in said trust accounts for a predetermined period, at least a portion of the funds being transferred to an administration account during that period.

32. A commemorative donation system according to claim 31, wherein
the funds are transferred from said trust accounts to other accounts maintained for said charitable organisations after said predetermined period.

33. A commemorative donation system according to any one of claims 22 to 32, wherein
the management system acts to provide details of a commemorated person, place or event and the nominated charitable organisations to an advertising agency,
said advertising agency then arranges for the publication of said acknowledgment.

34. A commemorative donation system according to claim 33, wherein
said acknowledgment is published in print media.

35. A commemorative donation system according to claim 33, wherein
said acknowledgment is published electronically.
